(19) United States
(12) Patent Application Publication
(10) Pub. No.: US 2024/0231481 A1
(43) Pub. Date: Jul. 11, 2024

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: SHUNJI FUJITA, Kanagawa (JP)

(21) Appl. No.: 18/393,948

(22) Filed: Dec. 22, 2023

(30) Foreign Application Priority Data
Jan. 5, 2023 (JP) 2023-000734

(51) Int. Cl. G06F 3/01; G06F 3/0346; G06F 3/04815; G06F 3/04842; G06V 40/10

(52) U.S. Cl. CPC G06F 3/013; G06F 3/0346; G06F 3/04815; G06F 3/04842; G06V 40/11

(57) ABSTRACT

An information processing apparatus includes: a display control unit configured to display a virtual object such that the virtual object is arranged in a three-dimensional space; a first acquisition unit configured to acquire information of a position of an operating body; a second acquisition unit configured to acquire information of a line-of-sight position of the user; and a control unit configured to switch between a first operation mode and a second operation mode, based on a distance between the position of the operating body and the line-of-sight position, and perform control to select the virtual object at the position of the operating body in the first operation mode, and display a display item indicating a direction to which the operating body is directed, and select the virtual object indicated by the display item in the second operation mode.

### BACKGROUND OF THE INVENTION

### Field of the Invention

The present invention relates to an information processing apparatus, an information processing method, and a storage medium.

### Description of the Related Art

In recent years, there has been proposed a cross reality (XR) system that makes users experience virtual reality using Head Mount Displays (HMDs). Japanese Patent Application Publication No. 2012-013514 discloses a technique that derives a three-dimensional position of a subject and fuses the three-dimensional position with a virtual object, based on feature information near an intersection between a scan line set to each image of the subject captured from a plurality of viewpoints, and a boundary between areas including color information.

Japanese Patent Application Publication No. 2017-27206 proposes an apparatus that attracts a virtual object to a user in a virtual three-dimensional space such that the virtual object displayed at a distant place is displayed within a range that a user's hand can reach.

However, even when a subject is fused with a virtual object or a distant virtual object is attracted to a user, there may be a case where a user operation of selecting a desired virtual object becomes complicated in a situation in which a plurality of virtual objects are arranged at various positions.

### SUMMARY OF THE INVENTION

The present invention provides a user interface that enables a user to easily select a desired virtual object from among a plurality of virtual objects arranged at various positions.

An information processing apparatus according to the present invention includes at least one memory and at least one processor which function as: a display control unit configured to display a virtual object such that the virtual object is arranged in a three-dimensional space that is a visual field of a user; a first acquisition unit configured to acquire information of a position of an operating body at a position of a hand of the user; a second acquisition unit configured to acquire information of a line-of-sight position of the user; and a control unit configured to switch between a first operation mode and a second operation mode, based on a distance between the position of the operating body and the line-of-sight position, and perform control to select the virtual object at the position of the operating body in the first operation mode, and display a display item indicating a direction to which the operating body is directed, and select the virtual object indicated by the display item in the second operation mode.

Further features of the present invention will become apparent from the following description of exemplary embodiments with reference to the attached drawings.

### BRIEF DESCRIPTION OF THE DRAWINGS

FIG. 1 is a view illustrating a configuration of an information processing system according to embodiment 1;

FIG. 2 is a view illustrating a configuration of an HMD according to embodiment 1;

FIG. 3 is a flowchart of operation mode switching processing according to embodiment 1;

FIG. 4 is a view for describing a convergence angle;

FIGS. 5A and 5B are views illustrating screen examples where a virtual object is operated by a hand;

FIG. 6 is a view illustrating a configuration of an information processing system according to embodiment 2;

FIG. 7 is a view illustrating a configuration of an HMD according to embodiment 2;

FIG. 8 is a view illustrating a configuration of a controller according to embodiment 2;

FIG. 9 is a flowchart of operation mode switching processing according to embodiment 2; and

FIG. 10 is a view illustrating a screen example where a virtual object is operated by the controller.

### DESCRIPTION OF THE EMBODIMENTS

Hereinafter, embodiments of the present invention will be described with reference to the drawings. An information processing apparatus according to the present invention provides a user interface for selecting as an operation target a virtual object arranged in a three-dimensional space that is a user's visual field. The information processing apparatus switches an operation mode based on a distance between a position of an operating body and a line-of-sight position of the user. The operating body is, for example, a user's hand or a controller, and exists at the position of the user's hand. The operation mode includes a hand operation mode of selecting a virtual object with the operating body, and a ray operation mode of selecting a virtual object with a display item of a beam shape (hereinafter, also referred to as a ray) that extends from the position of the operating body.

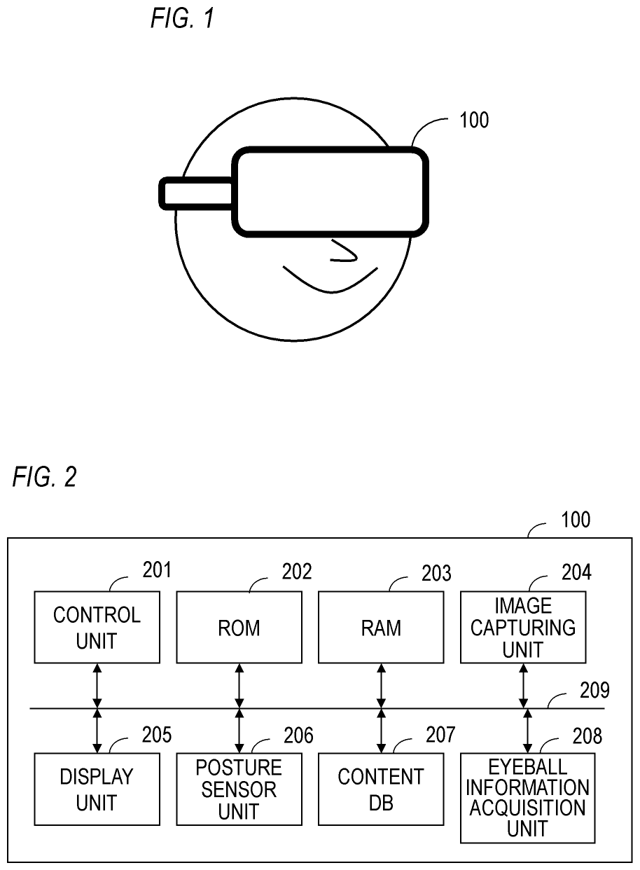

### Embodiment 1

<Configuration of Information Processing System> A configuration of an information processing system according to embodiment 1 will be described with reference to FIG. 1. The information processing system includes an HMD 100 as an information processing apparatus. Embodiment 1 will describe an example where the information processing apparatus is configured integrally with the HMD 100. However, the information processing apparatus may be an apparatus separate from the HMD 100. In this case, the information processing apparatus and the HMD 100 are connected such that data communication is possible therebetween. The information processing apparatus and the HMD 100 may be connected by wire or wirelessly.

The HMD 100 is a head-equipment type display apparatus (electronic device) that can be equipped to a user's head. The HMD 100 includes a camera that captures an image of a range of a front (front side) of the user, and a display that displays images to the user.

The HMD 100 displays on the display a synthesized image obtained by fusing a captured image captured by the camera and virtual objects that are items of Computer Graphics (CG) content. Consequently, the user can experience virtual reality with the user's eyes.

In embodiment 1, an operating body that operates a virtual object is the user's hand. The HMD 100 detects the user's hand from the captured image, acquires information of a position and a posture of the hand, and thereby makes a hand's motion act on the virtual object. Consequently, the user can intuitively operate the virtual object using the user's hand.

<Configuration of HMD> A configuration of the HMD 100 will be described with reference to FIG. 2. The HMD 100 includes a control unit 201, a Read Only Memory (ROM) 202, a Random Access Memory (RAM) 203, an image capturing unit 204, a display unit 205, a posture sensor unit 206, a content DB 207, and an eyeball information acquisition unit 208.

The control unit 201 controls each component of the HMD 100. The control unit 201 executes programs stored in the ROM 202 using the RAM 203 as a working memory, and controls overall processing of the HMD 100. The control unit 201 includes, for example, one or a plurality of processors (such as a CPU and a GPU).

The ROM 202 is a non-volatile memory that stores control programs to be executed by the control unit 201. The RAM 203 is a volatile memory that is used as the working memory for the control unit 201 to execute the programs, and a temporary storage area of various items of data.

The image capturing unit 204 includes, for example, two cameras (image capturing apparatuses). The two cameras are arranged near positions of the left and right eyes of the user at a time when the user is equipped with the HMD 100 to capture images of a space that the user looks at at a normal time. Images (captured images) obtained by capturing images of a subject (a range of the front of the user) by the two cameras are output to the RAM 203. Furthermore, the image capturing unit 204 can measure a distance from the HMD 100 to the subject by the two cameras (stereo cameras), and acquire the distance as distance information. Note that the image capturing unit 204 may include not only the two cameras, but also three or more cameras.

The display unit 205 (display control unit) displays a synthesized image of a captured image and a virtual object, a various operation menu for controlling the HMD 100, and the like as a three-dimensional image. The display unit 205 includes, for example, a display for which a liquid crystal panel, an organic Electro Luminescence (EL) panel, or the like is used. In a state where the user is equipped with the HMD 100, the organic EL panel is arranged in front of the left and right eyes of the user.

Note that the display unit 205 may be a device that uses a transreflective type half mirror. In this case, for example, the display unit 205 may superimpose virtual objects on a real space seen through the half mirror by a technique called Augmented Reality (AR), and display the virtual objects. Furthermore, the display unit 205 may display only an image of the virtual space without using a captured image by a technique called Virtual Reality (VR).

The posture sensor unit 206 detects a posture and a position of the HMD 100. The posture sensor unit 206 includes, for example, an Inertial Measurement Unit (IMU), and can acquire information of the posture and the position of the HMD 100 using the IMU. The posture sensor unit 206 outputs the acquired information of the posture and the position of the HMD 100 as position information to the RAM 203.

The content DB 207 stores information of virtual objects that are CG content. Note that the control unit 201 can switch a virtual object read from the content DB 207 (a virtual object used to generate a synthesized image), and generate the synthesized image.

The eyeball information acquisition unit 208 includes two eyeball sensors, and acquire left/right eyeball information of the user. The eyeball information includes, for example, information of a line-of-sight direction of the eyes, and information of the degree of refraction of the eyes. The two eyeball sensors are arranged near positions of the left and right eyes of the user. The eyeball sensors may be, for example, dedicated cameras that capture images of eyeballs.

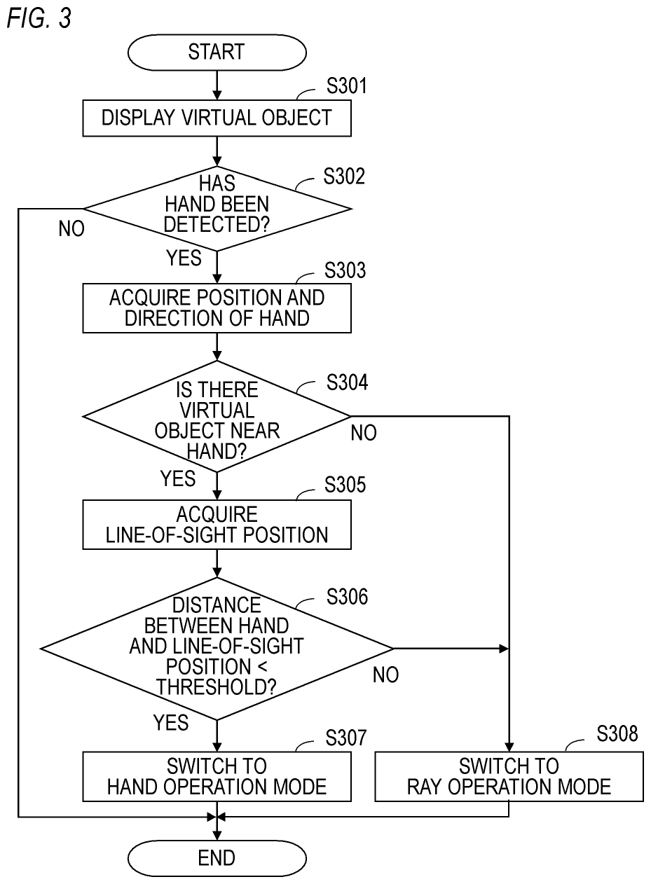

An internal bus 209 is a transmission path that connects between the respective processing blocks included in the HMD 100, and transmits and receives a control signal and data.

<Operation Mode Switching Processing> FIG. 3 is a flowchart illustrating operation mode switching processing for a virtual object according to embodiment 1. The control unit 201 switches between the hand operation mode (first operation mode) and the ray operation mode (second operation mode) based on a distance between the position of the hand and the line-of-sight position of the user. The hand operation mode is an operation mode that enables the user to perform various operations on a virtual object by directly touching and selecting the virtual object with the user's hand. The ray operation mode is an operation mode that enables the user to perform various operations on a virtual object by pointing a distal end portion of a ray to and selecting the virtual object. The ray is a display item of a beam shape that extends from the position of the user's hand, and is superimposed on the synthesized image and displayed. The user can point to a desired position with the ray. The operation mode switching processing illustrated in FIG. 3 is repeatedly executed at a predetermined cycle interval of approximately several tens of milliseconds.

In step S301, the control unit 201 displays a virtual object such that the virtual object is arranged in the three-dimensional space that is the user's visual field. The control unit 201 performs image processing of canceling an aberration of an optical system of the image capturing unit 204 and an optical system of the display unit 205 for an image (captured image) acquired by the image capturing unit 204. Furthermore, the control unit 201 generates a synthesized image by synthesizing one or a plurality of virtual objects acquired from the content DB 207 with the captured image having been subjected to the image processing, and displays the synthesized image on the display of the display unit 205.

The control unit 201 controls a position, a direction, and the size of the virtual object in the synthesized image based on the position information of the HMD 100 acquired by the posture sensor unit 206. In a case where, for example, a virtual object is arranged in the three-dimensional space indicated by the synthesized image and near a specific object that exists in a real space, the control unit 201 makes the virtual object larger as the distance between the specific object and the image capturing unit 204 is closer. By controlling the position, the direction, and the size of the virtual object in this way, the control unit 201 can generate the synthesized image showing as if an object of the virtual object were arranged in the real space.

In step S302, the control unit 201 determines whether or not the user's hand has been detected from the captured image acquired by the image capturing unit 204. More specifically, the control unit 201 determines whether or not a position of a hand articulation point of the user has been detected in a coordinate system of the captured image. In a case where the user's hand has been detected, the processing proceeds to step S303. In a case where the user's hand has not been detected, the operation mode switching processing illustrated in FIG. 3 is finished.

In step S303, the control unit 201 acquires information of the position and the direction of the user's hand based on information of the hand articulation point of the user detected in step S302. In step S302 and step S303, the control unit 201 can use a known hand tracking technique as a method for acquiring the information of the position and the direction of the user's hand.

The known hand tracking technique is, for example, a method for detecting a hand articulation point by machine learning. Furthermore, the known hand tracking technique may be a method for acquiring a distance from the image capturing unit 204 to the hand articulation point by disparity estimation of stereo matching and triangulation. Furthermore, the position of the hand is not limited to the hand articulation point, may be a position that can be acquired by known techniques, and may be a position of a fingertip or a joint of a finger or the like. The control unit 201 can acquire the information of the direction of the hand based on information of a plurality of positions on the hand.

In step S304, the control unit 201 determines whether or not a virtual object is arranged near the user's hand (within a predetermined range from the position of the user's hand). More specifically, the control unit 201 determines whether or not a distance between the position of the user's hand acquired in step S303 and the position of the virtual object is a first threshold or less. In a case where the plurality of virtual objects are arranged in step S301, the control unit 201 determines whether or not a distance between a position of each of the plurality of virtual objects and the position of the hand is the first threshold or less.

Note that the position of the virtual object may be, for example, a position of the center of gravity of the virtual object, or a position of the virtual object that is the closest to the HMD 100. The first threshold may be a preset value, and may be determined based on, for example, the size of the virtual object. More specifically, the first threshold may be ½ of the width in a horizontal direction of the size of the virtual object. Furthermore, the first threshold may be determined based on the position of the virtual object and a range that the user's hand can reach. The range that the user's hand can reach can be set in advance by, for example, measuring the range per user.

In a case where a virtual object is arranged near the user's hand, that is, in a case where a distance between the position of the user's hand and a position of one of the virtual objects is the first threshold or less, the processing proceeds to step S305. In a case where no virtual object is arranged near the user's hand, that is, in a case where a distance between the position of the user's hand and a position of a virtual object exceeds the first threshold, the processing proceeds to step S308.

In a case where it is determined in step S304 that no virtual object exists near the user's hand, the control unit 201 proceeds to step S308, and sets the ray operation mode to enable the user to select a virtual object with the ray. Hence, in the case where no virtual object exists near the user's hand, the control unit 201 may not execute the processing of determining whether or not to switch the operation mode (the processing from step S305 to step S307). Note that the determination processing in step S304 can be also omitted.

In step S305, the control unit 201 acquires information of the virtual line position that the user looks at based on the eyeball information related to the user's left and right eyeballs acquired by the eyeball information acquisition unit 208. The eyeball information includes, for example, information of the line-of-sight direction of the eyes and information of the degree of refraction of the eyes. The control unit 201 can acquire a convergence angle from the acquired eyeball information, and acquire a line-of-sight position and a distance from the HMD 100 to the line-of-sight position, based on the convergence angle and a distance between the left and right eyeballs.

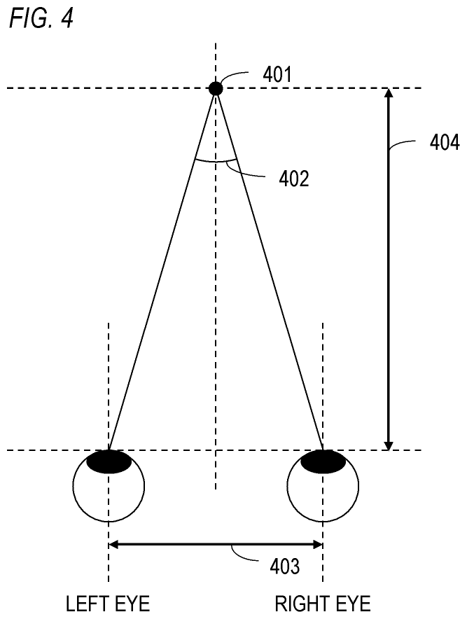

FIG. 4 is a view for describing a convergence angle. A line-of-sight position 401 is a position that the user looks at. A convergence angle 402 is an angle formed by a straight line that connects the left eye and the line-of-sight position 401, and a straight line that connects the right eye and the line-of-sight position 401. A distance 403 is a distance between the left eye and the right eye (e.g., a distance between the center of the eyeball of the left eye and the center of the eyeball of the right eye). A distance 404 is a distance from the HMD 100 to the line-of-sight position.

The convergence angle 402 can be obtained based on a line-of-sight direction of the right eye and a line-of-sight direction of the left eye acquired by the eyeball information acquisition unit 208. The line-of-sight position 401 of the user and the distance 404 from the HMD 100 to the line-of-sight position can be obtained by using information of the distance 403 between the left eye and the right eye and the trigonometric function of the convergence angle 402.

In step S306, the control unit 201 determines whether or not the distance between the position of the user's hand acquired in step S303 and the line-of-sight position of the user acquired in step S305 is smaller than a predetermined threshold. The predetermined threshold may be determined based on, for example, of the size of a virtual object that exists at the position of the hand, a distance between the virtual object that exists at the position of the hand and another virtual object, and the like. In a case where the distance between the position of the hand and the line-of-sight position of user is smaller than the predetermined threshold, the line-of-sight position of the user is directed to the virtual object that exists at the position of the user's hand, and the control unit 201 can select this virtual object as an operation target.

In a case where the distance between the position of the hand and the line-of-sight position of user is smaller than the predetermined threshold, the processing proceeds to step S307. In a case where the distance between the position of the hand and the line-of-sight of the user is the predetermined threshold or more, the processing moves to step S308.

Note that, in a case where a state where the distance between the position of the hand and the line-of-sight position of user is smaller than the predetermined threshold continues for a predetermined time, the control unit 201 may determine that the distance between the position of the hand and the line-of-sight position of user is smaller than the predetermined threshold taking into account that the user's line-of-sight physiologically moves. Furthermore, in a case where a state where the distance between the position of the hand and the line-of-sight position of user is the predetermined threshold or more continues for the predetermined time, the control unit 201 may determine that the distance between the position of the hand and the line-of-sight position of user is the predetermined threshold or more. By determining whether or not the state where the distance between the position of the hand and the line-of-sight position of user is smaller than the predetermined threshold continues for the predetermined time, the control unit 201 can accurately determine whether or not the user is looking at the virtual object on a user's own will.

In step S307, the control unit 201 switches the operation mode for the virtual object to the hand operation mode, and stops displaying the ray. That is, in a case where the operation mode has already been the hand operation mode, the control unit 201 continues the state of the hand operation mode. When the position of the user's hand acquired in step S303 overlaps the virtual object, the control unit 201 determines that the user selects this virtual object. The control unit 201 selects this virtual object as an operation target.

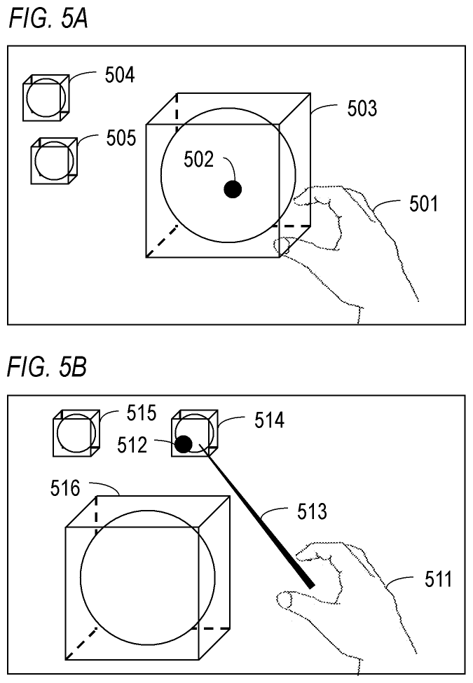

FIG. 5A is a view illustrating a screen example where a virtual object is operated in the hand operation mode. In the example in FIG. 5A, the user looks at a line-of-sight position 502 near the range that the use's hand can reach. The user directly selects a virtual object 503 from a plurality of arranged virtual objects by a hand 501 of the user. A virtual object 504 and a virtual object 505 are virtual objects that the user does not desire to operate since the user's line-of-sight is not directed thereto.

In step S308, the control unit 201 switches the operation mode for virtual objects to the ray operation mode, and displays a ray. In a case where the operation mode has already been the ray operation mode, the control unit 201 continues a state of the ray operation mode. The ray is displayed from the position of the user's hand along the direction of the user's hand. The direction of the hand may be a direction to which a palm of the hand is directed, or may be a direction that one of fingers points to.

The control unit 201 displays a ray from the position of the user's hand acquired in step S303 to a position of a virtual object that exists ahead of the direction of the user's hand. In a case where no virtual object exists ahead of the direction of the hand, the control unit 201 displays a ray from the user to the position at a predetermined distance. In a case where a virtual object exists ahead of the ray, the control unit 201 determines that the user points the ray to this virtual object, and selects this virtual object. The control unit 201 selects this virtual object as an operation target.

FIG. 5B is a view illustrating a screen example where a virtual object is operated in the ray operation mode. In the example in FIG. 5B, the user looks at a line-of-sight position 512 at a distant position that the user's hand cannot reach. The user selects a virtual object 514 from a plurality of arranged virtual objects with a ray 513 displayed in a beam shape from a position of a hand 511 of the user. A virtual object 515 and a virtual object 516 are virtual objects that the user does not desire to operate since the user's line-of-sight is not directed thereto.

According to above embodiment 1, the HMD 100 switches between the hand operation mode and the ray operation mode based on the distance between the line-of-sight position and the position of the hand of the user. By taking the line-of-sight into account, the user can easily operate a desired virtual object in a situation that a plurality of virtual objects are arranged at various positions irrespectively of a distance from the user to the virtual object.

### Embodiment 2

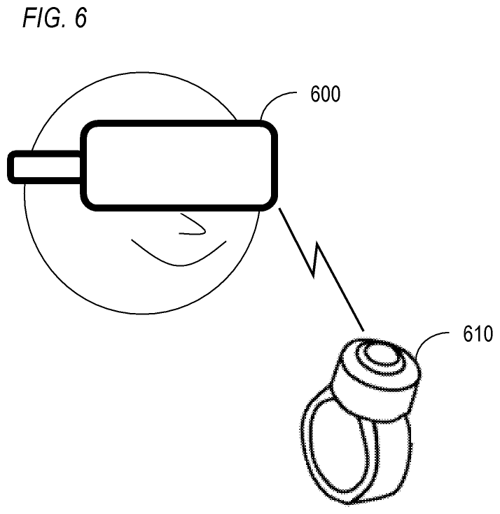

In embodiment 1, the HMD 100 switches the operation mode based on the position of the user's hand and the user's line-of-sight. By contrast with this, in embodiment 2, the information processing system includes a controller, and the HMD 100 switches the operation mode based on a position of the controller and a user's line-of-sight. Different contents from those of embodiment 1 will be described in detail, and the same contents as those in embodiment 1 will be omitted.

<Configuration of Information Processing System> A configuration of the information processing system according to embodiment 2 will be described with reference to FIG. 6. The information processing system includes an HMD 600 and a controller 610. The HMD 600 has a function of performing wireless communication with the controller 610 in addition to the function of the HMD 100 described in embodiment 1. The HMD 600 receives from the controller 610 information (operation information) of a user's operation on the controller 610, and executes various control based on the received operation information.

The controller 610 is an apparatus that controls the HMD 600, and has a function of performing wireless communication with the HMD 600. When the user operates the controller 610, the controller 610 transmits the operation information of the user to the HMD 600. The HMD 600 is controlled based on the received operation information.

The controller 610 has, for example, a finger ring (ring-type) shape that can be equipped to a user's finger as illustrated in FIG. 6. In a case where the controller 610 can be equipped to the user's hand, the user can freely move the hand in a state where the user holds the controller 610. Note that the shape of the controller 610 is not limited to the finger ring type. The controller 610 only needs to have a form that allows the hand to freely move, and may have, for example, a shape such as a glove type that can be equipped to the hand, or may have a shape that the user's hand can hold in such a way that the user can easily use the controller 610.

The controller 610 includes a button including a built-in Optical Track Pad (hereinafter, referred to as an OTP) that can sense a planar movement amount. When, for example, the user holds down the OTP button, the HMD 600 displays on a display a menu including a pointer. By placing the finger in contact with the OTP to slide in an arbitrary direction, the user can point the pointer to a desired item of the displayed menu. By performing an operation of pointing the pointer to the desired item, and pushing the OTP button, the user can determine selection of this item.

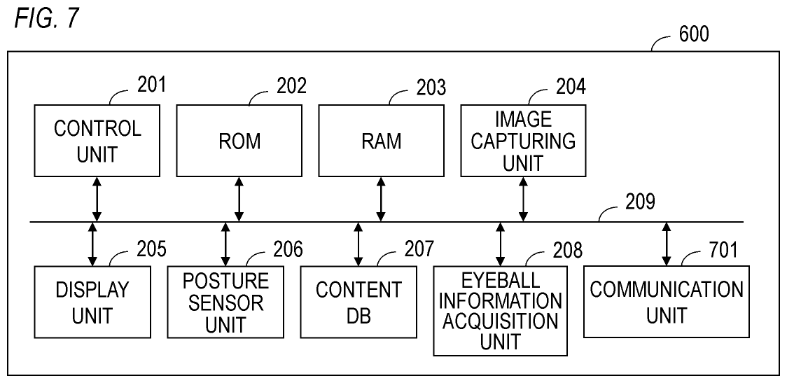

Note that the number of the controllers 610 is not limited to one, and may be plural. The information processing system may include, for example, the two controllers 610, and the HMD 600 may be controlled by the two controllers 610 equipped to the respective left and right hands of the user.

<Configuration of HMD> A configuration of the HMD 600 will be described with reference to FIG. 7. Similar to the HMD 100 according to embodiment 1, the HMD 600 includes the control unit 201, the ROM 202, the RAM 203, the image capturing unit 204, the display unit 205, the posture sensor unit 206, the content DB 207, and the eyeball information acquisition unit 208. The HMD 600 further includes a communication unit 701.

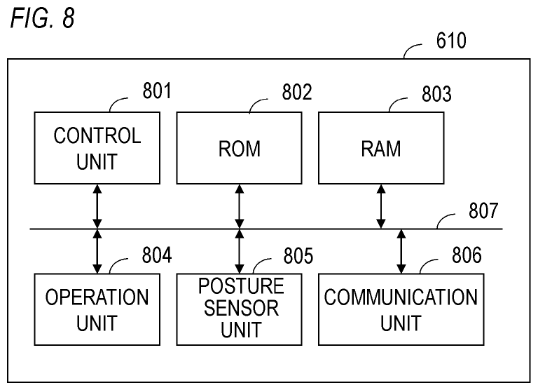

The communication unit 701 performs wireless communication with the controller 610. The communication unit 701 performs wireless communication that conforms to, for example, Bluetooth (registered trademark).

<Configuration of Controller> A configuration of the controller 610 will be described with reference to FIG. 8. The controller 610 includes a control unit 801, a ROM 802, a RAM 803, an operation unit 804, a posture sensor unit 805, and a communication unit 806.

The control unit 801 controls each component of the controller 610. The control unit 801 executes programs stored in the ROM 802 using the RAM 803 as a working memory, and controls overall processing of the controller 610. The control unit 801 includes, for example, one or a plurality of processors (such as a CPU and a GPU).

The ROM 802 is a non-volatile memory that stores control programs to be executed by the control unit 801. The RAM 803 is a volatile memory that is used as the working memory for the control unit 801 to execute the programs, and a temporary storage area of various items of data.

The operation unit 804 includes a button including the built-in OTP. Operation information of, for example, pushing on the OTP and sliding of the finger is transmitted to the HMD 600 via the communication unit 806. By, for example, sliding the finger on the OTP, the user can move the pointer displayed on the display of the HMD 600 to a desired position. By pushing the OTP button, the user can instruct the HMD 600 to perform processing corresponding to the item selected by the pointer. As described above, the user can control the HMD 600 by a combination of sliding of the finger on the OTP and pushing of the button.

The operation unit 804 may include an arbitrary operation member instead of the OTP as long as the user can perform an operation by physical contact. For example, the operation unit 804 may include at least one of a touch pad, a touch panel, a cross key, a joy stick, and a track pad apparatus instead of the OTP.

The posture sensor unit 805 detects a posture and a position of the controller 610. The posture sensor unit 805 includes, for example, an Inertial Measurement Unit (IMU), and can acquire information of the posture and the position of the HMD 100 using the IMU. The posture sensor unit 805 outputs the acquired information of the posture and the position of the controller 610 as position information to the RAM 803.

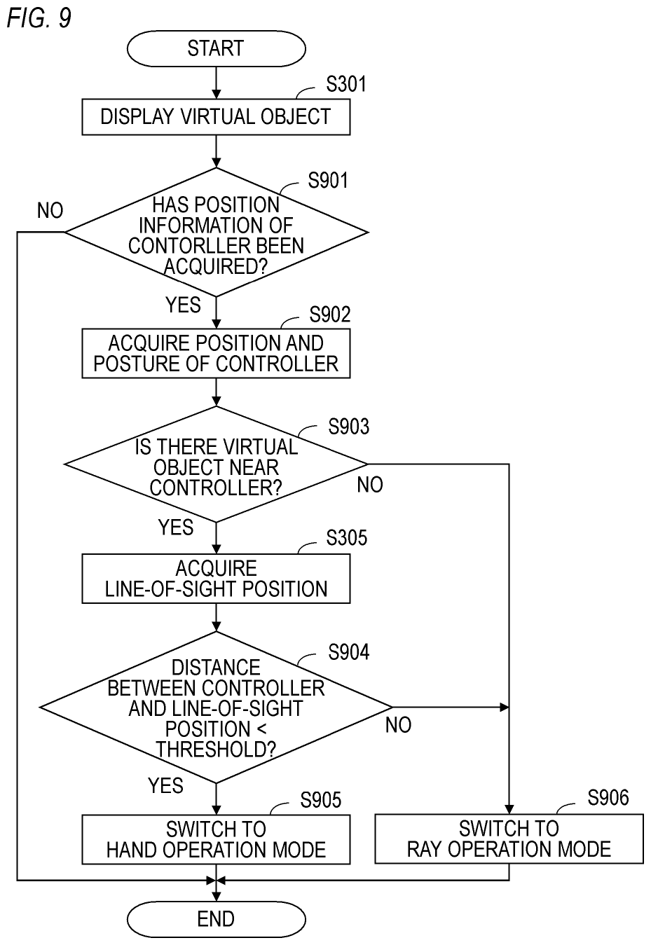

The communication unit 806 performs wireless communication with the HMD 600. The communication unit 806 performs wireless communication that conforms to, for example, Bluetooth (registered trademark). An internal bus 807 is a transmission path that connects between the respective processing blocks included in the controller 610, and transmits and receives a control signal and data.

<Operation Mode Switching Processing> FIG. 9 is a flowchart illustrating operation mode switching processing for a virtual object according to embodiment 2. The control unit 201 switches between the hand operation mode (first operation mode) and the ray operation mode (second operation mode) based on a distance between a position and the line-of-sight position of the controller 610. The operation mode switching processing illustrated in FIG. 9 is repeatedly executed at a certain cycle interval of approximately several tens of milliseconds. The same processing as that in FIG. 3 will be assigned the same reference numerals, and detailed description thereof will be omitted.

The HMD 600 and the controller 610 establish connection of wireless communication before start of the operation mode switching processing illustrated in FIG. 9, and can communicate with each other. The controller 610 continuously transmits operation information of the user on the operation unit 804, and information of the position and the posture of the controller 610 acquired by the posture sensor unit 805 to the HMD 600 at a predetermined cycle.

In step S301, the control unit 201 displays a virtual object on the display of the display unit 205 similar to step S301 in FIG. 3.

In step S901, the control unit 201 determines whether or not position information of the controller 610 (the information of the position and the posture) has been acquired. When receiving the information of the position and the posture of the controller 610 from the controller 610 via the communication unit 701, the control unit 201 can determine that the position information of the controller 610 has been acquired. Furthermore, when, for example, wireless communication with the controller 610 is disconnected for some reason, the control unit 201 determines that the position information of the controller 610 is not acquired. In a case where the position information of the controller 610 has been acquired, the processing proceeds to step S902. In a case where the position information of the controller 610 has not been acquired, the operation mode switching processing illustrated in FIG. 9 is finished.

In step S902, the control unit 201 acquires the information of the position and the posture of the controller 610 from the position information received via the communication unit 701.

In step S903, the control unit 201 determines whether or not a virtual object is arranged near the controller 610 (within a predetermined range from the position of the controller 610). More specifically, the control unit 201 determines whether or not a distance between the position of the controller 610 acquired in step S902 and a position of the virtual object is a second threshold or less. In a case where a plurality of virtual objects are arranged in step S301, the control unit 201 determines whether or not a distance between a position of each of the plurality of virtual objects and the position of the controller 610 is the second threshold or less. The second threshold can be determined similarly to the first threshold in step S304.

In a case where a virtual object is arranged near the controller 610, that is, in a case where the distance between the position of the controller 610 and a position of one of virtual objects is the second threshold or less, the processing moves to step S305. In a case where a virtual object is not arranged near the controller 610, that is, in a case where the distance between the position of the controller 610 and a position of a virtual object exceeds the second threshold or less, the processing moves to step S906.

In step S305, the control unit 201 causes the eyeball information acquisition unit 208 to acquire information of a line-of-sight position that the user looks at similar to step S305 in FIG. 3.

In step S904, the control unit 201 determines whether or not a distance between the position of the controller 610 acquired in step S902 and the line-of-sight position of the user acquired in step S305 is smaller than the predetermined threshold. The predetermined threshold may be determined based on, for example, the size of a virtual object that exists at the position of the controller 610, a distance between the virtual object that exists at the position of the controller 610 and another virtual object, and the like. In a case where the distance between the position of the controller 610 and the line-of-sight position is smaller than the predetermined threshold, the line-of-sight position of the user is directed to the virtual object that exists at the position of the controller 610, and the control unit 201 can select this virtual object as an operation target.

In a case where the distance between the position of the controller 610 and the line-of-sight position is smaller than the predetermined threshold, the processing proceeds to step S905. In a case where the distance between the position of the controller 610 and the line-of-sight is the predetermined threshold or more, the processing moves to step S906.

In step S905, the control unit 201 switches the operation mode for the virtual object to the hand operation mode, and stops displaying the ray. That is, in a case where the operation mode has already been the hand operation mode, the control unit 201 continues the state of the hand operation mode. When the position of the controller 610 acquired in step S902 overlaps the virtual object, the control unit 201 determines that the user selects this virtual object. The control unit 201 selects this virtual object as an operation target.

In step S906, the control unit 201 switches the operation mode for a virtual object to the ray operation mode, and displays a ray. In a case where the operation mode has already been the ray operation mode, the control unit 201 continues a state of the ray operation mode. The ray is displayed from the position of the controller 610 along the direction of the controller 610. The direction of the controller 610 may be, for example, a direction to which a circular area formed by a ring is directed, or may be a direction to which a predetermined portion on the controller 610 is directed. The direction of the controller 610 can be acquired based on the information of the position and the posture of the controller 610 acquired in step S902.

The control unit 201 displays a ray from the position of the controller 610 acquired in step S902 to a position of a virtual object that exists ahead of the direction to which the controller 610 is directed. In a case where no virtual object exists ahead of the direction of the ray, the control unit 201 displays a ray from the user to the position at the predetermined distance. In a case where a virtual object exists ahead of the ray, the control unit 201 determines that the user points the ray to this virtual object, and selects this virtual object. The control unit 201 selects this virtual object as an operation target.

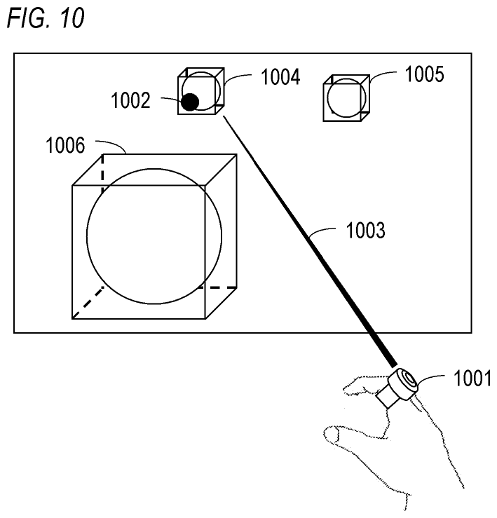

FIG. 10 is a view illustrating a screen example where a virtual object is operated by a controller 1001. In the example in FIG. 10, the user looks at a line-of-sight position 1002 at a distant position that the user's hand cannot reach. Even in a case where the user's hand is not included in a captured image, the user selects a virtual object 1004 from a plurality of virtual objects with a ray 1003 displayed from a position of the controller 1001 to a direction to which the controller 1001 is directed. A virtual object 1005 and a virtual object 1006 are virtual objects that the user does not desire to operate since the user's line-of-sight is not directed thereto.

Note that, according to determination processing in step S904, the control unit 201 may further determine whether or not the user takes a posture for operating a virtual object. In a case where, for example, the position of the controller 610 is not in front of the user, the control unit 201 can determine that the user does not take the posture for operating a virtual object. In a case where the user does not take the posture for operating the virtual object, the control unit 201 may proceed to step S905 and switch the operation mode to the hand operation mode. By determining whether or not the user takes the posture for operating the virtual object, the control unit 201 can prevent an unnecessary ray from being displayed.

According to above embodiment 2, the HMD 100 switches between the hand operation mode and the ray operation mode based on the distance between the user's line-of-sight position and the position of the controller 610. In a case where the information processing system includes the controller 610, and the user's hand is equipped with the controller 610, the HMD 100 can acquire the position of the controller 610 as the position of the hand. Consequently, even when the user's hand that performs an operation is not included in a captured image, the user can easily operate a desired virtual object in a situation that a plurality of virtual objects are arranged at various positions.

The present invention has been described in detail based on the preferred embodiments. However, the present invention is not limited to these specific embodiments, and also covers various embodiments without departing from the gist of the present invention. Furthermore, each of the above embodiments is merely an embodiment of the present invention, and can be also combined with various embodiments as appropriate.

The present invention can provide a user interface that enables the user to easily select a desired virtual object among a plurality of virtual objects arranged at various positions.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-000734, filed on Jan. 5, 2023, which is hereby incorporated by reference herein in its entirety.

What is claimed is:

1. An information processing apparatus comprising at least one memory and at least one processor which function as:
a display control unit configured to display a virtual object such that the virtual object is arranged in a three-dimensional space that is a visual field of a user;
a first acquisition unit configured to acquire information of a position of an operating body at a position of a hand of the user;
a second acquisition unit configured to acquire information of a line-of-sight position of the user; and
a control unit configured to switch between a first operation mode and a second operation mode, based on a distance between the position of the operating body and the line-of-sight position, and perform control to
select the virtual object at the position of the operating body in the first operation mode, and
display a display item indicating a direction to which the operating body is directed, and select the virtual object indicated by the display item in the second operation mode.

2. The information processing apparatus according to claim 1, wherein the control unit sets the first operation mode in a case where the distance between the position of the operating body and the line-of-sight position is smaller than a predetermined threshold, and sets the second operation mode in a case where the distance between the position of the operating body and the line-of-sight position is larger than the predetermined threshold.

3. The information processing apparatus according to claim 2, wherein the control unit sets the first operation mode in a case where a state where the distance between the position of the operating body and the line-of-sight position is smaller than the predetermined threshold continues for a predetermined time, and sets the second operation mode in a case where a state where the distance between the position of the operating body and the line-of-sight position is larger than the predetermined threshold continues for the predetermined time.

4. The information processing apparatus according to claim 1, wherein the control unit sets the second operation mode in a case where the virtual object is not arranged within a predetermined range from the position of the operating body.

5. The information processing apparatus according to claim 1, wherein the display item is an item of a beam shape that extends from the position of the operating body.

6. The information processing apparatus according to claim 1, wherein the control unit performs control not to display the display item in a case where the operating body is not located in front of the user.

7. The information processing apparatus according to claim 1, wherein
the operating body is the hand of the user, and
the first acquisition unit acquires information of the position of the operating body by detecting the hand of the user from a captured image of the three-dimensional space.

8. The information processing apparatus according to claim 1, wherein
the operating body is a controller, and
the first acquisition unit acquires information of a position of the controller acquired by a sensor included in the controller as information of the position of the operating body.

9. An information processing method comprising:
displaying a virtual object such that the virtual object is arranged in a three-dimensional space that is a visual field of a user;
acquiring information of a position of an operating body at a position of a hand of the user;
acquiring information of a line-of-sight position of the user; and
switching between a first operation mode and a second operation mode, based on a distance between the position of the operating body and the line-of-sight position, and performing control to
select the virtual object at the position of the operating body in the first operation mode, and
display a display item indicating a direction to which the operating body is directed, and select the virtual object indicated by the display item in the second operation mode.

10. A non-transitory computer-readable storage medium that stores a program for causing a computer to execute an information processing method comprising:
displaying a virtual object such that the virtual object is arranged in a three-dimensional space that is a visual field of a user;
acquiring information of a position of an operating body at a position of a hand of the user;
acquiring information of a line-of-sight position of the user; and
switching between a first operation mode and a second operation mode, based on a distance between the position of the operating body and the line-of-sight position, and performing control to
select the virtual object at the position of the operating body in the first operation mode, and
display a display item indicating a direction to which the operating body is directed. and select the virtual object indicated by the display item in the second operation mode.
